(19) United States
(12) Patent Application Publication
(10) Pub. No.: US 2009/0129064 A1
(43) Pub. Date: May 21, 2009

(54) Convertible flashlight/headlight

(76) Inventor: Noel E. Zeller, Harrison, NY (US)

Correspondence Address: COOPER & DUNHAM, LLP, 30 Rockefeller Plaza, 20th Floor, NEW YORK, NY, 10112, US

(21) Appl. No.: 11/985,424

(22) Filed: Nov. 15, 2007

(51) Int. Cl. F21V 21/084; F21L 4/00

(52) U.S. Cl. 362/105; 362/157

(57) ABSTRACT

A convertible light device useable as a flashlight and a headlight, comprising a body portion having an enlongated tube and a head portion, said head portion having a removeable light section with a lighting element and a battery bay for receiving batteries for powering the lighting element, said removeable light section having a strap adapted to be worn on a user's head, wherein the body portion defines a hollow interior for storing the strap, whereby the light device may be used as a hand held flashlight when the light section is connected to said body portion, and may be used as a handlamp when the light section is mounted to a user's head with the strap.

### BACKGROUND OF THE INVENTION

The present invention relates to a lighting device that can be operated in flashlight and headlight modes.

Typical flashlights have an elongated body for accepting two D cell batteries, and a head portion having a light that can be switched on or off. Attempts have been made to adapt such flashlights for use as headlights by designing head harnesses for holding the flashlight. These are typically clumsy, large and hard to use.

Typical headlights, dedicated as such, have a strap for mounting the headlight around a user's head. However, they are not well adapted to use as hand carry flashlights.

Some attempts have been made to combine flashlights and headlights into a single device. For example, U.S. Pat. No. 6,953,260 (also shown in U.S. Pat. No. D503,238) shows a flashlight-headlight. A body portion holds the batteries, and front housing portion holds the lighting elements. The headlight is always attached to the body to receive the necessary battery power. Also, the headlight may be attached to a belt clip or a bicycle, and there does not appear to be any easy way to mount the device to a user's head.

### SUMMARY OF THE INVENTION

In one embodiment, an object of the present invention is to provide a lighting device which operates in a flashlight mode and is easily convertible to operate in a headlight mode.

In one embodiment, an object of the present invention is to provide a lighting device having a headlight mode is easily adapted to be mounted on a user's head.

In one embodiment, an object of the present invention is to provide a lighting device capable of storing user items such as paper money in a waterproof receptacle.

In one embodiment, an object of the present invention is to provide a convertible lighting device operable in a flashlight or headlight mode which stores a headlight strap when operable in a flashlight mode.

The invention provides a convertible light device useable as a flashlight and a headlight, comprising a body portion having an enlongated tube and a head portion, said head portion having an interior region for removeably receiving a light section comprising a lighting element and a battery bay for receiving batteries for powering the lighting element, said removeable light section having a strap adapted to be worn on a user's head, wherein the interior region extends to the elongated tube to define a hollow interior for storing the strap, whereby the light device may be used as a hand held flashlight when the light section is received in the interior region, and may be used as a handlamp when the light section is removed from the interior region and mounted to a user's head with the strap.

The invention provides a convertible light device useable as a flashlight and a headlight, comprising a body portion having an enlongated tube and a head portion, said head portion having an interior region for removeably receiving a light section comprising a lighting element and a battery bay for receiving batteries for powering the lighting element, said removeable light section having a strap adapted to be worn on a user's head, wherein the interior region extends to the elongated tube to define a hollow interior for storing the strap, whereby the light device may be used as a hand held flashlight when the light section is received in the interior region, and may be used as a handlamp when the light section is removed from the interior region and mounted to a user's head with the strap, wherein the head portion has a front retention ring to hold the removeable light section within the interior region, wherein the front retention ring is mounted to the body portion with a hinge, and is held to the body portion by a releasable clamp, wherein the elongated tube has a smaller cross-section than said head portion, wherein the lighting element comprises at least one LED, and further comprising a seal for sealing the hollow interior when the light section is received in the interior region, a power circuit for providing at least two different power levels to said lighting element for providing two different levels of illumination, wherein the elongated tube has a plurality of resilient high friction inserts along its outer surface, and wherein the interior region has sufficient size for storing user articles in addition to the strap.

### BRIEF DESCRIPTION OF THE DRAWINGS

FIG. 1 is a perspective view of an embodiment according to the invention;

FIG. 2 is a perspective view of the embodiment of FIG. 1, showing the headlight head portion removed and separate from the body portion;

FIG. 3 is a plan view of the battery and lamp part of the headlight module that houses the batteries, light and reflector;

FIG. 4 is a perspective view of the head band holder which is part of the headlight module that connects to the battery and lamp part of FIG. 3, and which receives the strap ends;

FIG. 5 is a side view of the reflector which is a part of the headlight module;

FIG. 6 is a perspective view of the lens which is a part of the headlight module;

FIG. 7 is a perspective view of the lens cover which is a part of the headlight module;

FIG. 8 is a perspective view of the hinged front retaining ring which is hinged at the head portion of the body to enable removal at the headlight module;

FIG. 9 is a perspective view of a clip toggle forming part of the hinge assembly for the hinged front retaining ring;

FIG. 10 is a perspective view of a clip forming part of the hinge assembly for the hinged front retaining ring;

FIG. 11 is a perspective view of the battery box or cassette; and

FIG. 12 is a perspective view of the battery box cover,

### DETAILED DESCRIPTION OF A PREFERRED EMBODIMENT

A preferred embodiment of the invention will now be described, but the invention is not limited to this embodiment.

The invention provides a convertible light device useable as a flashlight and a headlight, comprising a body portion having an enlongated tube and a head portion, said head portion having an interior region for removeably receiving a light section comprising a lighting element and a battery bay for receiving batteries for powering the lighting element, said removeable light section having a strap adapted to be worn on a user's head, wherein the interior region extends to the elongated tube to define a hollow interior for storing the strap, whereby the light device may be used as a hand held flashlight when the light section is received in the interior region, and may be used as a handlamp when the light section is removed from the interior region and mounted to a user's head with the strap.

The head portion may have a front retention ring to hold the removeable light section within the interior region. The front retention ring may be mounted to the body portion with a hinge, and held to the body portion by a releasable clamp. The elongated tube may have a smaller cross-section than said head portion. The lighting element may comprise at least one LED. The device may further comprise a seal for sealing the hollow interior when the light section is received in the interior region. The device may include a power circuit for providing at least two different power levels to said lighting element for providing two different levels of illumination. The elongated tube may have a plurality of resilient high friction inserts along its outer surface. The interior region may have sufficient size for storing user articles in addition to the strap.

The invention provides a convertible light device useable as a flashlight and a headlight, comprising a body portion having an enlongated tube and a head portion, said head portion having an interior region for removeably receiving a light section comprising a lighting element and a battery bay for receiving batteries for powering the lighting element, said removeable light section having a strap adapted to be worn on a user's head, wherein the interior region extends to the elongated tube to define a hollow interior for storing the strap, whereby the light device may be used as a hand held flashlight when the light section is received in the interior region, and may be used as a handlamp when the light section is removed from the interior region and mounted to a user's head with the strap, wherein the head portion has a front retention ring to hold the removeable light section within the interior region, wherein the front retention ring is mounted to the body portion with a hinge, and is held to the body portion by a releasable clamp, wherein the elongated tube has a smaller cross-section than said head portion, wherein the lighting element comprises at least one LED, and further comprising a seal for sealing the hollow interior when the light section is received in the interior region, a power circuit for providing at least two different power levels to said lighting element for providing two different levels of illumination, wherein the elongated tube has a plurality of resilient high friction inserts along its outer surface, and wherein the interior region has sufficient size for storing user articles in addition to the strap.

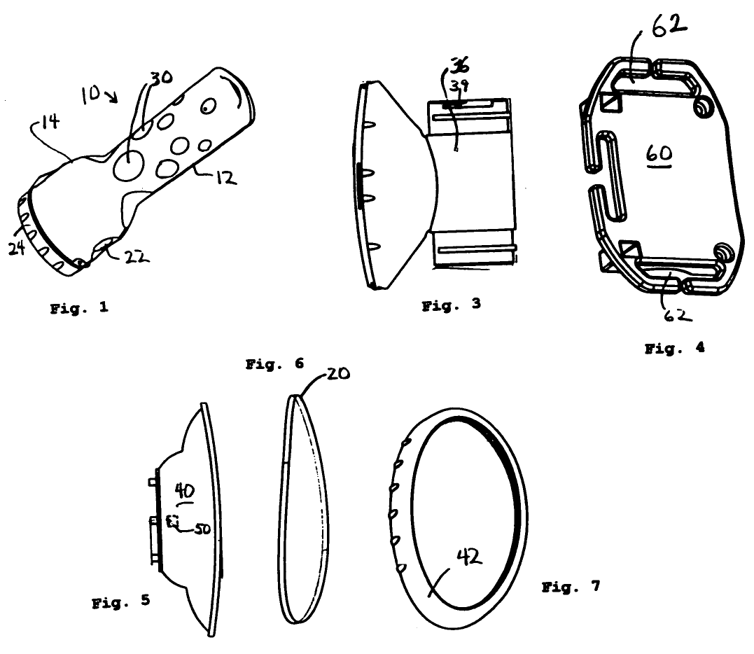

FIG. 1 shows a perspective view of an embodiment of a convertible light device 10 according to the invention. The light device 10 comprises a body portion in the shape of an elongated tube 12 and an enlarged head portion 14. The head portion 14 has a removeable light section 16 with a light element behind a clear lens 20. The device 10 has a push button switch cover 22 on its side which is operable to switch the light element to three different lighting states: high, low and off.

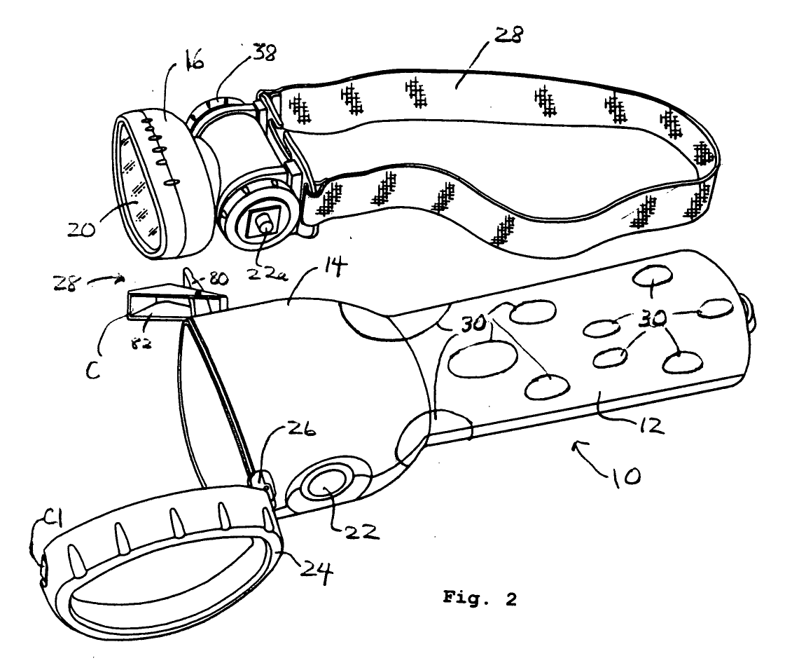

The head portion 14 has a front retaining ring 24 which attached with a hinge 26 on one side and a latch 28 on the other side of the head portion. When the latch is unlatched, the retaining ring 24 can swing on its hinge to the position shown in FIG. 2, which also shows the removeable light section 16 completely removed from the body portion.

The removeable light section 16 has a strap 28 length may be adjusted. The light section 16 also has a battery bay for receiving batteries for powering the light element (which may be one or more LEDs). The light section has a switch element 22a which is connected to a power circuit, batteries and light element so that the removeable light section 16 can be used as an independent light device worn on a user's head or a hand carry light. The switch 22a may be activated by the push button switch cover 22 on the head portion 14 when the light section is fully received in the head portion.

As shown in FIG. 4 the rear of the removeable light section 16 has a slightly concave surface adapted to fit comfortably against a user's forehead when worn on a user's head.

The interior of the body portion 12 is hollow and can be used to store the strap 28, as well as other user items such as paper money. The retaining ring 24 co-acts with the light section so that when fully latched a waterproof seal is provided to prevent entry of fluid such as moisture or water into the interior of the body portion. The retaining ring or light section may have a seal or o-ring to aid in the seal function. The light section 16 itself may also be waterproof.

The outside of the body portion 12 has resilient rubber or similar type grip inserts 30 with a high coefficient of friction to aid in gripping the device so that it can be easily held while used as a flashlight. The rear end of the body portion has a molded ring which can accept another strap for carrying the body portion.

The battery holder 36 of FIG. 3 is formed of two clamshell like pieces bonded together and forms the main part of the removeable light section 16. On the inside of the headlamp module is a reflector 40 (see FIG. 5). A lens cover 42 of FIG. 7 receives a clear front lens 20 of FIG. 6 and is attached to the front of the battery holder 36. The interior of the battery holder defines a generally cylindrical compartment for receiving a battery holder module 37 (See FIGS. 11 and 12).

The battery holder module 37 can be removed for replacing the batteries. To remove the battery holder, a removeable screw cap 38 is provided which engages the threads 39 on the top in FIG. 3. An LED 50 is mounted at the base of the reflector and the terminals of the LED are connected in circuit with the switch 22a and battery power.

FIG. 4 shows the head-band holder 60 which is connected to the bottom of the battery box holder of FIG. 3. As described above, the head band holder 60 has a concave face which can be fitted against a user's head when the headlamp is worn by a user. Strap slots 62 along the edge of the headband hold can accommodate the strap 28 to be worn around the head.

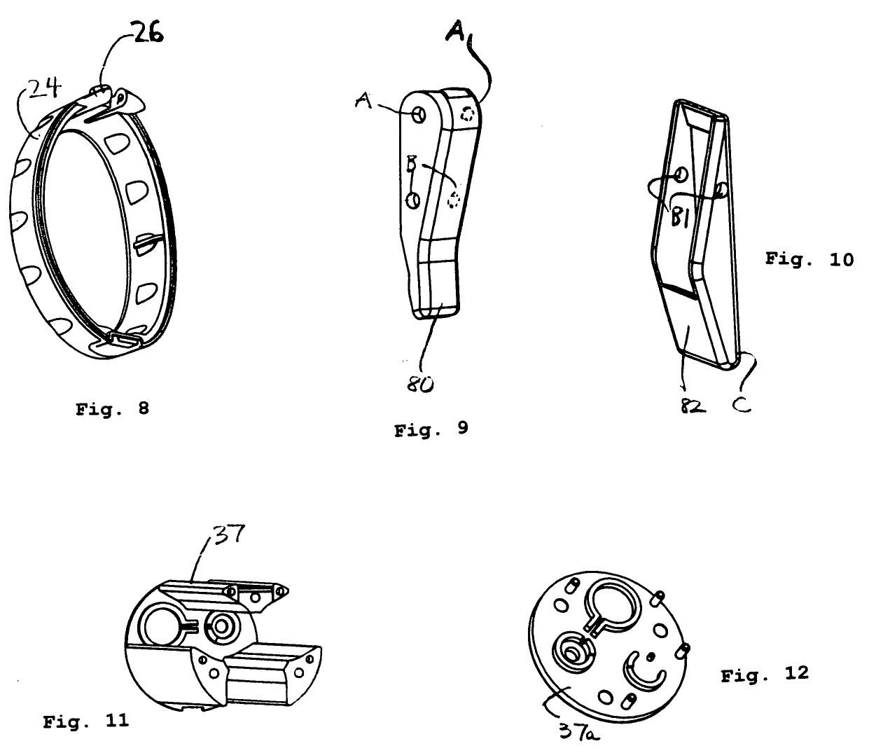

FIGS. 8, 9, and 10 show components of the latch 28 that enable the lens holder of FIG. 8 to be hinged to the main body and swing away to enable removal of the headlight module and access to the interior storage compartment of the flashlight body tube. The retaining ring 24 has a hinge 26 with a pin that is received on one side of the front of the flashlight body tube. This enables the lens holder to swing between closed and open positions relative to the flashlight body tube. The latch 28 comprises clip toggle 80 and clip 82. Holes A on the clip toggle 80 of FIG. 9 receive a hinge pin which is connected to holes on the head portion 14. Holes B on the clip toggle 80 of FIG. 10 receive another hinge pin which also passes through holes B1 on the clip 82 of FIG. 9. When the lenses holder of FIG. 8 is positioned in the closed position against the front face of the head portion 14 of the flashlight, end c of the clip 82 can engage the lip C1 of the lens holder, and the clip toggle 80 can pivot towards the head portion of the flashlight to tighten the connection of the lens holder to the head portion keeping it airtight and waterproof.

FIGS. 11 and 12 show components of the battery holder module 37 which receives three AAA batteries. The cover 37a of FIG. 12 may be fitted onto the battery box of FIG. 11 in a removeable or permanent fashion. The batteries are inserted through the three side openings in module 37. The terminals for connecting the battery power to the light circuit are at the bottom of the battery module 37. The batteries are connected in a series circuit to provide about 4.5 volts. Because an odd number (3) of batteries are provided, the battery module 37 has a conductor for completing the circuit from the third battery in series from the cover back to the bottom of the battery module 37. Springs may be provided at the negative terminal ends of each battery slot in module 37 or cover 37a for good battery contact with the terminals.

Although one embodiment has been described, the invention is not limited to this embodiment. The scope of the invention is defined by the attached claims.

I claim:

1. A convertible light device useable as a flashlight and a headlight, comprising:
a body portion having an enlongated tube and a head portion, said head portion having an interior region for removeably receiving a light section comprising a lighting element and a battery bay for receiving batteries for powering the lighting element, said removeable light section having a strap adapted to be worn on a user's head, wherein the interior region extends to the elongated tube to define a hollow interior for storing the strap, whereby the light device may be used as a hand held flashlight when the light section is received in the interior region, and may be used as a handlamp when the light section is removed from the interior region and mounted to a user's head with the strap.

2. The convertible light device according to claim 1, wherein the head portion has a front retention ring to hold the removeable light section within the interior region.

3. The convertible light device according to claim 2, wherein the front retention ring is mounted to the body portion with a hinge, and is held to the body portion by a releasable clamp.

4. The convertible light device according to claim 1, wherein the elongated tube has a smaller cross-section than said head portion.

5. The convertible light device according to claim 1, wherein the lighting element comprises at least one LED.

6. The convertible light device according to claim 1, further comprising a seal for sealing the hollow interior when the light section is received in the interior region.

7. The convertible light device according to claim 1, including a power circuit for providing at least two different power levels to said lighting element for providing two different levels of illumination.

8. The convertible light device according to claim 1, wherein the elongated tube has a plurality of resilient high friction inserts along its outer surface.

9. The convertible light device according to claim 1, wherein the interior region has sufficient size for storing user articles in addition to the strap.

10. A convertible light device useable as a flashlight and a headlight, comprising:
a body portion having an enlongated tube and a head portion, said head portion having an interior region for removeably receiving a light section comprising a lighting element and a battery bay for receiving batteries for powering the lighting element, said removeable light section having a strap adapted to be worn on a user's head, wherein the interior region extends to the elongated tube to define a hollow interior for storing the strap, whereby the light device may be used as a hand held flashlight when the light section is received in the interior region, and may be used as a handlamp when the light section is removed from the interior region and mounted to a user's head with the strap, wherein the head portion has a front retention ring to hold the removeable light section within the interior region, wherein the front retention ring is mounted to the body portion with a hinge, and is held to the body portion by a releasable clamp, wherein the elongated tube has a smaller cross-section than said head portion, wherein the lighting element comprises at least one LED, and further comprising a seal for sealing the hollow interior when the light section is received in the interior region, a power circuit for providing at least two different power levels to said lighting element for providing two different levels of illumination, wherein the elongated tube has a plurality of resilient high friction inserts along its outer surface, and wherein the interior region has sufficient size for storing user articles in addition to the strap.
